(19) United States
(12) Patent Application Publication
(10) Pub. No.: US 2015/0178794 A1
(43) Pub. Date: Jun. 25, 2015

(54) Method And Browser For Controlling Network Media Information Interaction

(71) Applicant: Tencent Technology (Shenzhen) Company Limited, Shenzhen (CN)

(72) Inventors: Fen Sheng, Shenzhen (CN); Yu Lin, Shenzhen (CN)

(21) Appl. No.: 14/588,832

(22) Filed: Jan. 2, 2015

Related U.S. Application Data
(63) Continuation of application No. PCT/CN2014/083739, filed on Aug. 5, 2014.

(30) Foreign Application Priority Data
Aug. 20, 2013 (CN) 201310364578.0

(51) Int. Cl. G06Q 30/02; G06F 3/0354; G06T 3/20

(52) U.S. Cl. CPC G06Q 30/0277; G06T 3/20; G06F 3/03541

(57) ABSTRACT

Method and device of displaying an advertisement on a webpage are disclosed. The method includes: displaying a clickable animated object associated with the advertisement on a display; obtaining the distance between the clickable animated object and the current position of a pointer cursor or contact on the display; and comparing the obtained distance with a trigger distance. When the obtained distance is greater than the trigger distance, the clickable animated object is moved in the direction approaching the pointer cursor or contact on the display; and when the obtained distance is no greater than the trigger distance, the current position of the clickable animated object is maintained on the display.

### PRIORITY CLAIM AND RELATED APPLICATIONS

This application is a continuation application of PCT Patent Application No. PCT/CN2014/083739, entitled “METHOD AND BROWSER FOR CONTROLLING NETWORK MEDIA INFORMATION INTERACTION” filed on Aug. 5, 2014, which claims priority to Chinese Patent Application No. 201310364578.0, entitled “METHOD AND BROWSER FOR CONTROLLING NETWORK MEDIA INFORMATION INTERACTION” filed on Aug. 20, 2013, both of which are incorporated by reference in their entirety.

### FIELD OF THE TECHNOLOGY

The present application relates to the field of Internet technologies, and in particular, to a method and browser for controlling network media information interaction.

### BACKGROUND OF THE TECHNOLOGY

Advertisements are a major source of revenue for websites and other webpage providers. Typically, web page providers receive payment from advertisers only when the advertisements are clicked, since clicking indicates some interest from webpage viewers. However, advertisements are generally uninteresting to webpage viewers. Too many advertisements dampen visitors' interest to the webpages. Therefore, the present application provides a method of making advertisements interactive and interesting, as well as boosting the clicking by webpage visitors.

### SUMMARY

In accordance with some implementations of the disclosed technology, a method of displaying an advertisement in a webpage, comprising: displaying a clickable animated object associated with the advertisement on the display; obtaining a distance between the clickable animated object and a current position of a pointer cursor or contact on the display; and comparing the obtained distance with a trigger distance: when the obtained distance is larger than the trigger distance, moving the clickable animated object in a direction approaching the pointer cursor or contact on the display; and when the obtained distance is no larger than the trigger distance, maintaining a current position of the clickable animated object on the display.

In another aspect, a device comprises one or more processors, memory, and one or more program modules stored in the memory and configured for execution by the one or more processors. The one or more program modules include instructions for performing the method described above. In another aspect, a non-transitory computer readable storage medium having stored thereon instructions, which, when executed by a device, cause the device to perform the method described above.

### BRIEF DESCRIPTION OF THE DRAWINGS

The aforementioned features and advantages of the technology as well as additional features and advantages thereof will be more clearly understood hereinafter as a result of the following detailed description of preferred embodiments when taken in conjunction with the drawings.

FIG. 1 is a schematic flow chart of a method for controlling network media information interaction in accordance with some embodiments;

FIG. 2 is a schematic view of functional modules in a browser for controlling network media information interaction in accordance with some embodiments;

FIG. 3 is a flowchart of a method for displaying an advertisement in a webpage in accordance with some embodiments;

FIG. 4 is a diagram of an example implementation of a device for displaying advertisements in webpages in accordance with some embodiments;

FIG. 5A is a schematic view of a picture of an advertising example;

FIG. 5B is a schematic view of a picture of mouse interaction after an interactive component is added to the picture shown in FIG. 5A;

FIG. 5C is a schematic view of a picture of mouse interaction after an interactive component is added to the picture shown in FIG. 5A;

FIG. 5D is a schematic view of a further picture of mouse interaction after an interactive component is added to the picture shown in FIG. 5A;

FIG. 6A is a schematic view of an example implementation of keyboard interaction in accordance with some embodiments;

FIGS. 6B to 6D are schematic views of example implementations of click interaction in accordance with some embodiments, respectively;

FIG. 7 is a schematic view of an interaction example in accordance with some embodiments; and

FIGS. 8A and 8B are schematic views of an interactive advertisement in accordance with some embodiments.

Similar reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. In other instances, well-known methods, procedures, components, and circuits have not been described in detail so as not to unnecessarily obscure aspects of the embodiments.

The technical terms involved in the embodiments of the present application include:

Network media advertisement: Network media advertisement is a form of advertising conducted through digital and network technologies which provides promotional information for users at computers, mobile phones, and other terminals.

AS script: AS is an abbreviation of ActionScript, that is, action description, which is programming language used to add an advanced animation or interaction in the production of Flash, and by using this type programming language, a complicated interactive animation can be created in Flash.

Cookie: A Cookie is generated by a server and sent to a user-agent (which is generally a browser), and the browser may save a key/value of the Cookie into a text file in a directory, and send the Cookie to the server next time the same website is visited; the server can use the manner in which Cookies contain information arbitrarily to filter and regularly maintain the information, so as to judge a state in HTTP transmission. The most typical application of Cookies is to determine whether a registered user has logged on to a website, the user may be prompted by a dialog box inquiring whether to keep user information next time the user enters the website, for the purpose of simplifying the registration procedure.

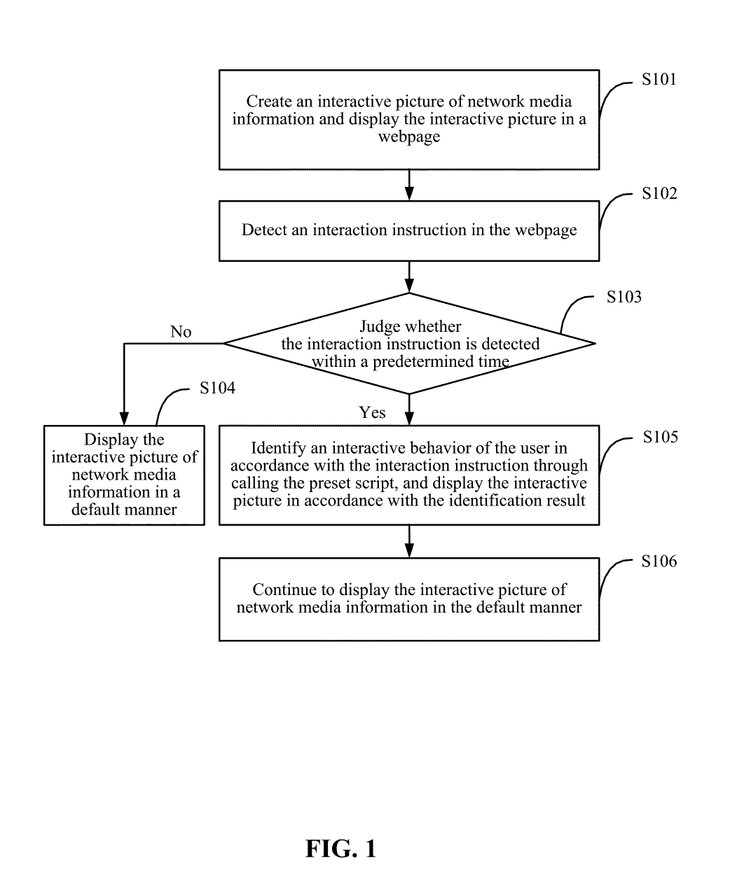

In accordance with some embodiments, FIG. 1 shows a method for controlling network media information interaction, which includes the following steps.

In accordance with some embodiments, in Step S101, a device creates an interactive picture of network media information and displays the interactive picture in a webpage, wherein the interactive picture includes a preset script for an interactive animation.

The interactive picture includes a network media interactive advertisement. For example, a corresponding interactive animation can be played with the movement of a user's mouse. For another example, a picture that attracts users to click is displayed on an advertising page, such as QQ, a microblogging avatar, a user name, and other registration information of a user are displayed, and so on.

The preset script includes an AS2 script and an AS3 script or other scripts. This embodiment especially can support implementation of a network media interactive advertisement through an application to which an AS3 script is added.

In addition, the timing of presenting an interactive picture of a network media advertisement in a webpage can be set according to requirements, or also can be randomly displayed after a client user opens a browser.

In accordance with some embodiments, in Step S102, the device detects an interaction instruction triggered by a client on the webpage.

After the interactive picture is displayed on the webpage, the client user can actively interact with an animation on the interactive picture according to the user's own interest, for example, by moving a mouse to play with the animation on the interactive picture play, or clicking the interactive picture to trigger the display of the animation on the interactive picture due to the click operation of the user.

In accordance with some embodiments, in Step S103, the device judges whether the interaction instruction is detected within a predetermined time; if detected, the process proceeds to Step S105; if not detected, the process proceeds to Step S104.

In accordance with some embodiments, in Step S105, the device identifies an interactive behavior of the user in accordance with the interaction instruction through calling the preset script, and displays the interactive picture in accordance with the identification result.

In accordance with some embodiments, in Step S104, the device displays the interactive picture in a default manner. Displaying in the default manner means that the device displays the interactive picture without receiving any instruction or input from a user.

In Step S106, in accordance with some embodiments, an interactive animation that can be played, corresponding to the movement of a user's mouse, is loaded onto/into an interactive picture. For example, after the user opens a webpage, an interactive picture of a network media advertisement is presented on the webpage; at this time, if the user moves the mouse, an interactive animation moves with the cursor. The device calls the preset script according to the mouse movement instruction to identify and acquire the mouse movement trajectory when the mouse movement instruction triggered by the client on the webpage is detected.

During specific implementation, a mouse coordinate value can be acquired through the preset script, so as to produce interaction effects of the mouse following the animation, the following is a representation of the technology in script, and the code is edited and presented as follows:

For Flash AS2 scripting language:

bear_mc.onEnterFrame = function ( )
{

var type:Number = this._x − _xmouse
this._xscale = type >0 ? 100 : −100
if (type <0)
{

this._x += (_xmouse −this._x) / 10

}else
{

this._x += (_xmouse −this._x) / 10

}

}

For a Flash AS3 scripting language:

var type:Number = 0
bear_mc.addEventListener(Event.ENTER_FRAME,onEnter);
function onEnter (event:Event) :void
{

type = this.x − mouseX
scaleX = type >0 ? 1 : −1

if (type <0)

{

this.x += (mouseX −this.x) / 10

}else
{

this.x += (mouseX −this.x) / 10

}

}

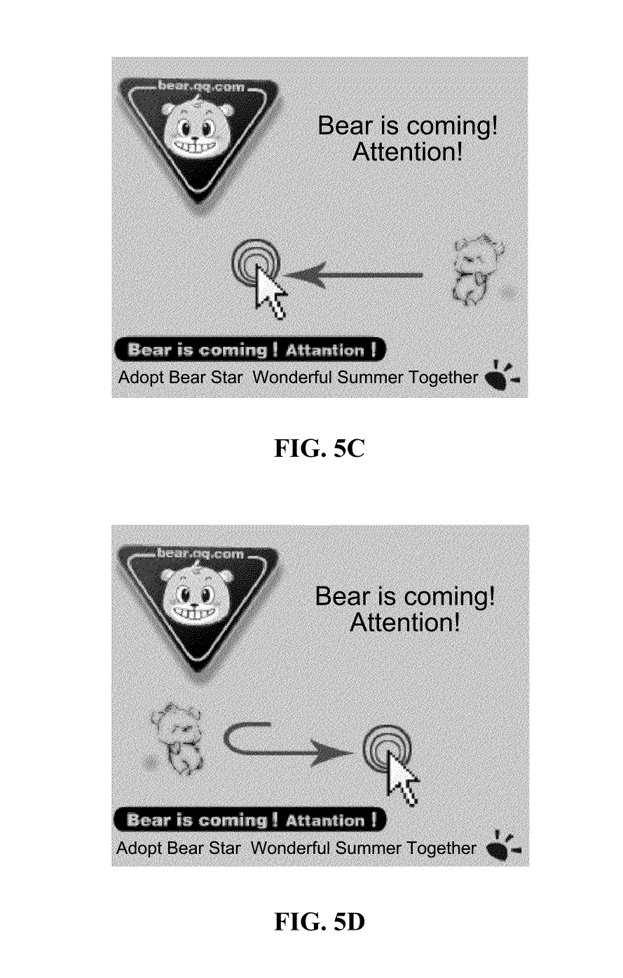

FIG. 5A illustrates an image when an interactive component is not added to an advertising picture. If the interactive component is added to the advertising, a running direction of the bear can be controlled through the user's mouse sliding effects. When the user slides the mouse to the right, the bear may run right with the mouse, and chase after the mouse, as shown in FIG. 5B; when the user's mouse turns left, the bear may turn around with the mouse, and chase left, as shown in FIG. 5C; similarly, when the mouse moves back and forth, the bear may also chase back and forth accordingly, as shown in FIG. 5D.

In accordance with some embodiments, the device calls the preset script according to a click instruction to identify and acquire a click behavior of the user when the click instruction triggered by the client on the webpage is detected.

In accordance with some embodiments, the device loads personal privacy information of the user to the interactive picture. In some embodiments, the browser needs to have permission to load personal privacy information of the user, and also needs to identify the identity of the user. The personal privacy information of the user may be registration information of the user on various applications, and the most common is registration information on, for example, QQ, microblogging, mails, etc., wherein an avatar, a name, etc., of the user can be involved.

In accordance with some embodiments, the application registration information of a current user is acquired at first, wherein the browser and a backend server agree on having permission to use the registration information of the user. In some embodiments, if the user has logged on to an application in the browser and a log-on historical record is not cleared, the application registration information of the user is acquired from a local cookie in the browser; if the user has not logged on to an application in the browser or a log-on historical record has been cleared, the application registration information of the user is acquired from the backend server.

Next, the application registration information (such as a QQ avatar of the user or a user name, etc.) is loaded onto the interactive picture, and finally the interactive picture in which the application registration information is loaded is displayed on the webpage.

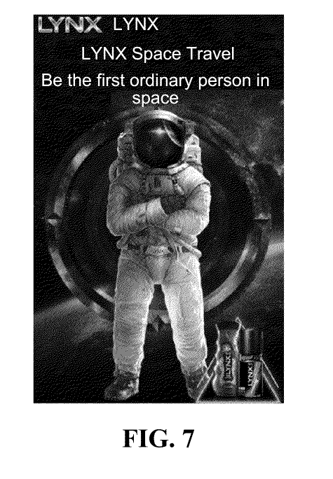

For example, a user avatar and a user name may appear in the interactive animation, which can only be seen by a user but cannot be browsed by others. In the advertising picture shown in FIG. 7, the head of the character can be replaced with a social network avatar of a current user.

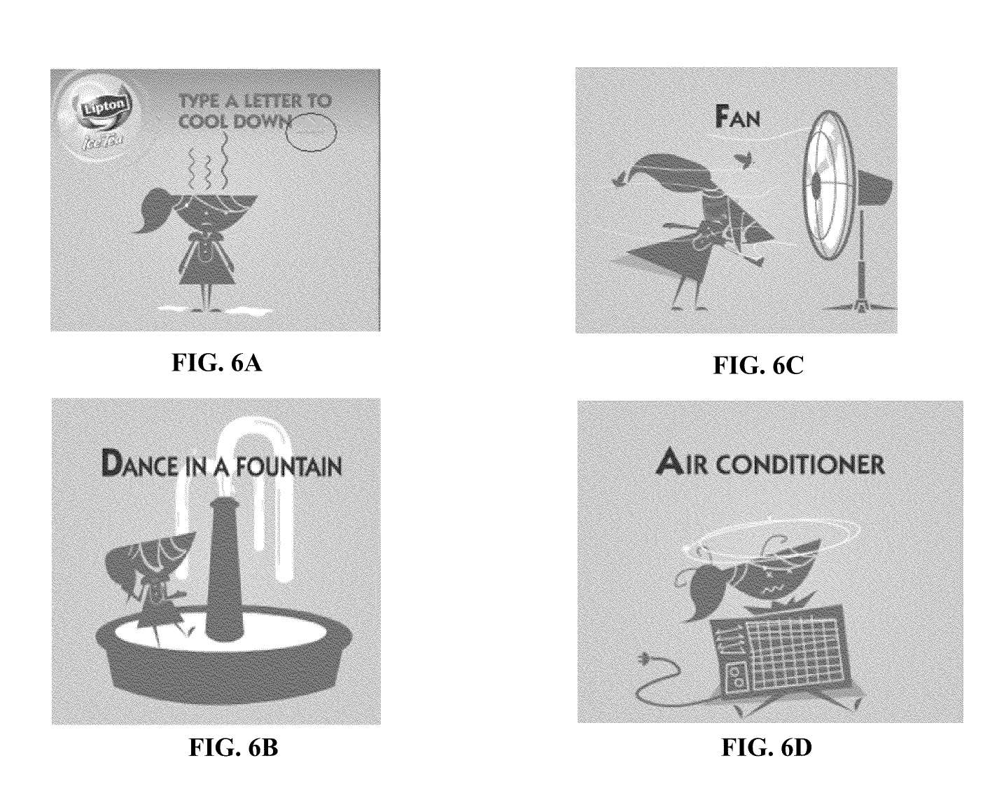

As the case shown in FIG. 6A, keyboard interaction can be implemented, as well as in an interactive picture of network media advertisement. When a user taps a letter key, the device triggers a corresponding animation, and displays interactive advertising corresponding to the letter. Also, as advertising cases shown in FIG. 6B, FIG. 6C and FIG. 6D, with a click operation of the user, triggering of a corresponding animation can be implemented.

In accordance with some embodiments, in Step S106, the device continues to play the interactive picture in a default manner after displaying the interactive animation is completed.

Specifically, after displaying an interactive animation in a current interactive picture is completed, the interactive picture continues to be played in the default manner, and the picture may be the original interactive picture or a following animation picture.

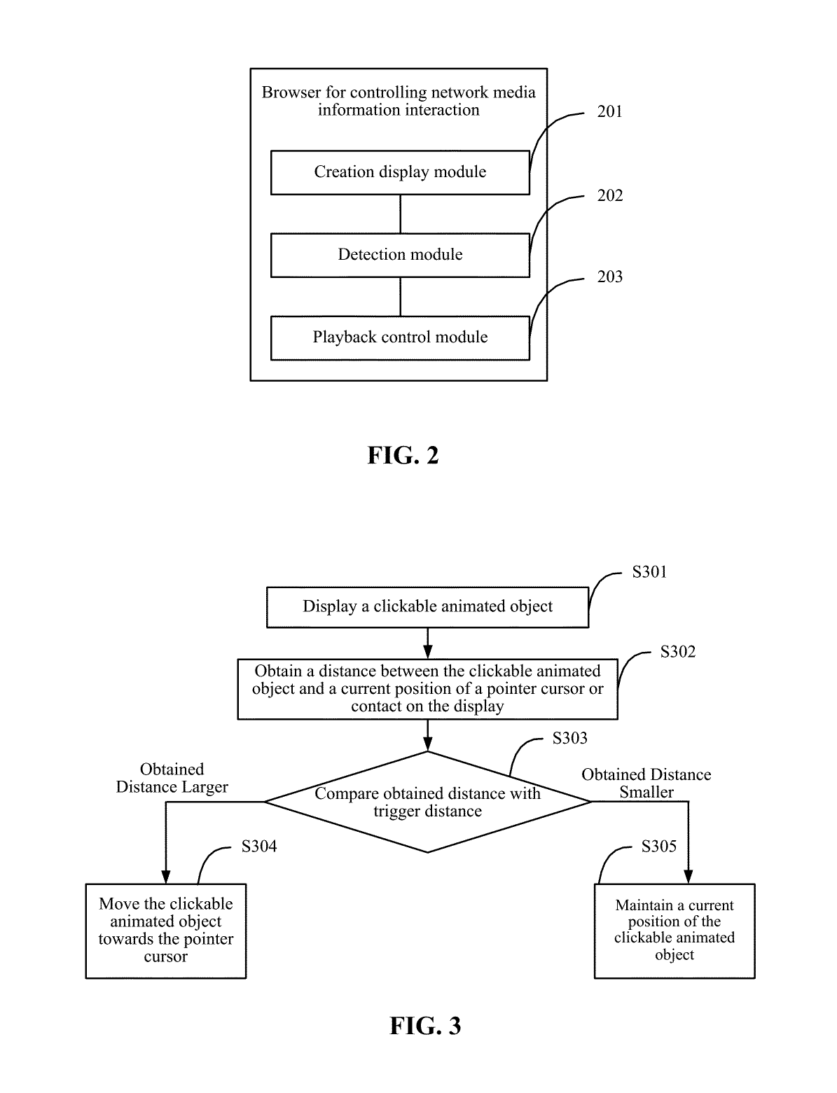

FIG. 2 illustrates a browser for controlling network media information interaction, which includes: a creation display module 201, a detection module 202, and a display control module 203.

The creation display module 201 is used for creating an interactive picture and displaying the interactive picture in a webpage.

The detection module 202 is used for detecting an interaction instruction triggered in the webpage.

The display control module 203 is used for calling the preset script according to the interaction instruction to identify an interactive behavior of a user, and displaying the interactive picture according to an identification result.

Further, the display control module 203 is used for displaying the interactive picture in a default manner.

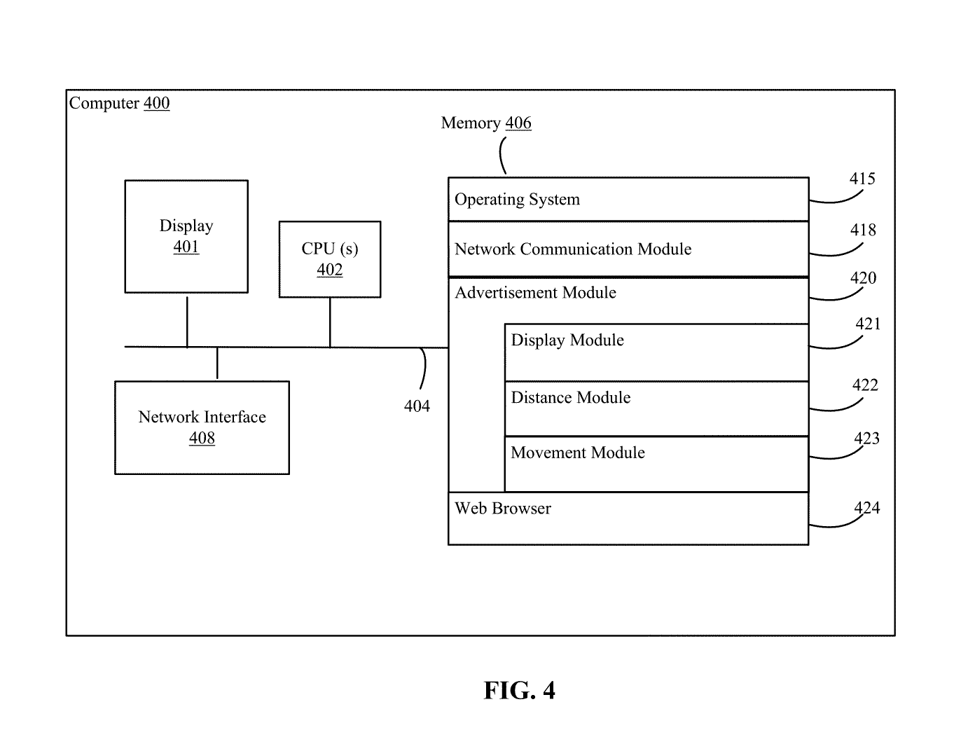

In accordance with some embodiments, FIG. 3 is a flowchart of a method of displaying an advertisement in a webpage. In some embodiments, the method is performed on a device of having one or more processors, memory, and a display, such as a desktop computer, a laptop, a tablet, a smart phone, etc.

In accordance with some embodiments, in Step S301, the device displays a clickable animated object (e.g., an animated character that is representative of an advertiser, a product, an animated character that is designed to be attractive and interesting to the viewer, etc.) associated with the advertisement on the display. In some embodiments, the clickable animated object is a character as shown in FIGS. 5 to 8. In some embodiments, the animated character is displayed as part of the advertisement image (e.g., the animated character is displayed over a background image containing advertising information). In some embodiments, the animated character can be displayed first, without any background image, and the advertising information can be displayed after the animated character is clicked on by the user. For example, an animated character representing the advertised product or the advertiser can be downloaded with the webpage and started moving on the webpage in accordance with the description contained herein, and once the animated character is clicked on by the user, a new webpage or an advertising image containing advertising information is downloaded and displayed to the user. In some embodiments, the animated character is composed of an animation part, and a script that downloads the advertising information based on an embedded link in the animated character and optionally based on the timing and appearance of the animated character. For example, the animated character can raise signs for different product offers at different times during the animation, and different advertisement content will be downloaded and displayed when the click is detected at different times as the signs for different offers are raised by the animated character.

In accordance with some embodiments, the device detects a clicking operation when the pointer cursor or contact is placed on the clickable animated object; and in response to the clicking operation, the device displays the advertisement associated with the clickable animated object. The clicking operation can include broad variety operations, such as double clicking by a mouse, a long touch by a finger, pushing the “enter” button on a keyboard, pushing a displayed button on a smart phone, etc. An advertisement could be an advertisement animation on the webpage or an advertisement webpage. In some embodiments, the movement of the clickable animated object is triggered when the pointer cursor or contact enters a boundary of the advertisement for the first time. For example, an advertisement includes a dog chasing a Frisbee in a frame, and the dog is a clickable animated object. The frame can be the boundary of the advertisement. Alternatively, the cursor pointer is displayed as a Frisbee and a dog is chasing the Frisbee-like cursor. There can be an invisible circle surrounding the dog, and the circle is an invisible boundary of the advertisement. When the pointer cursor moves into the invisible circle, the clickable animated object is triggered as being clicked.

In accordance with some embodiments, the animated object is not displayed with an advertisement. That is, the animated object is the only thing that is displayed on the display without an advertisement image as background. In some embodiments, the animated object is a mini advertisement with little information (e.g., it can be the logo or avatar of a company or service). There may be a little bit of information that gives the user some hint regarding what the advertisement would be about. For example, the animated character for McDonald's (e.g., the McDonald's clown) can hold up a small sign that says “Free drinks this Saturday.” Or the user's own avatar can hold a balloon that says “→Fun at Sea World”. When the animated object is clicked, the advertisement for free drinks at McDonald's or a promotional video for Sea World can be displayed.

In accordance with some embodiments, the clickable animated object is displayed concurrently with the advertisement, and the method further comprises: detecting a clicking operation when the pointer cursor or contact is placed on the clickable animated object; and in response to the clicking operation, displaying additional content associated with the advertisement. In this embodiment, the animated object is part of the advertisement. For example, the animated object can come from the advertisement. The advertisement can be a pop-up ad that is displayed when the webpage is loaded, and the animated object can be still initially in the pop-up ad, and become animated after the user moves the cursor into the pop-up window of the advertisement. In some embodiments, the animation and movement of the animated object is not triggered until the cursor enters the display region of the advertisement. The movement of the animated object may be confined within the frame of the advertisement, or can be confined with the webpage, or not confined at all. In this embodiment, the additional content can be a video, another webpage, an online storefront, an app store, etc.

In accordance with some embodiments, the device acquires information of a user of the device; and determines at least part of content of the clickable animated object in accordance with the acquired information of the user. In some embodiments, the acquired information includes a friend's avatar, purchase history, social network activity, web browsing habit, etc. In some embodiments, acquiring information of a user of the device includes getting the current log-in information of the user. And determining the at least part of the content of the clickable animated object in accordance with the acquired information of the user includes the device sending the log-in information to the user and a server acquires additional information of the user and sending the at least part of content of the clickable animated object to the device. For example, the user's or a friend's avatar could be part of the object to make it fun to click the object. For another example, a server or a device may determine a brand that is the most interesting or relevant to the user based on past purchase history, internet using habit and/or online social activities of the user. Part of the content of the animated object is then reflecting the determined product or merchant. In some embodiments, the device receives recommended advertisement for the user based on the user's purchase history, and then selects the animated object (e.g., game characters, super heroes, princesses, cute animals, animated movie characters, etc.) based on the user's interests. In addition, the device may select the style and subject/topic of the animation (e.g., funny, cool, elegant, cute, etc., and dancing, eating, flying, doing a sport, etc.) based on the user's interests. For example, the device is able to select an animated object from an object database

In accordance with some embodiments, the device changes the content of the clickable animated object continuously or periodically; and when detecting the clicking operation when the pointer cursor or contact is placed over the clickable animated object, displays an advertisement corresponding to the content of the clickable animated object being displayed at the time of clicking. For example, the object represents a coupon whose discount percentage is constantly changing. For another example, the animated object is a different mascot of different companies. These mascots are shown in turn, so that one mascot is replaced by another if not being clicked by the user for a predetermined period of time. In some embodiments, the relationship between the animated object and the conveyed advertising information is more subtle. The same character in the animated object may show different deals. For example, the color of the animated bear is constantly changing, and different colors correspond to different promotion points, which can be converted into rewards.

In accordance with some embodiments, in Step 302, the device obtains the distance between the clickable animated object and the current position of a pointer cursor or contact on the display. In some embodiments, the contact refers to the contact generated by a finger or a stylus touching the touch-sensitive display. The pointer cursor refers to the cursor generated by the mouse or a touch input on a touch pad of the device.

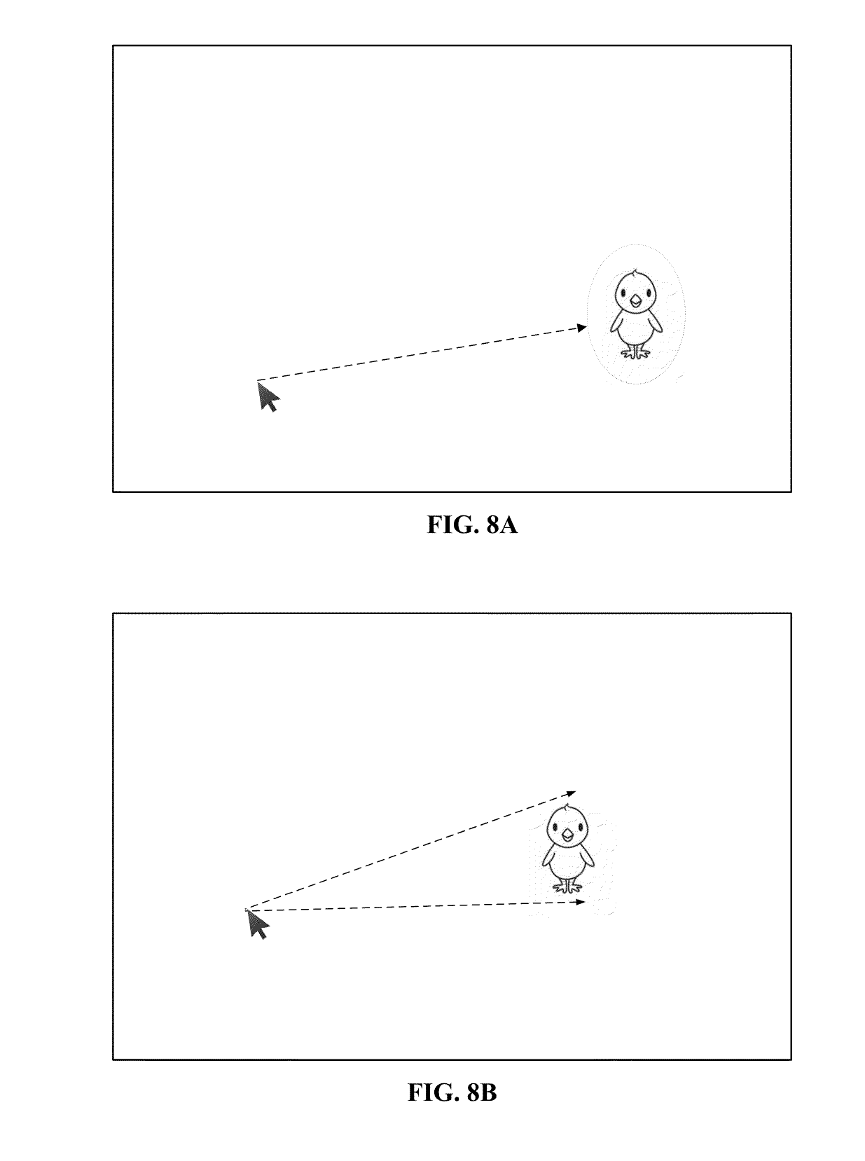

The distance can be calculated based on the position of the clickable animated object and the position of the pointer cursor or contact. The distance can be based on the center of the animated object or the closest point to the cursor in the animated object. For example, in FIG. 8A, the animated bird has an invisible elliptical boundary, and the obtained distance, as shown in the line with arrow, is the distance from the top of the pointer cursor to the closest point on the invisible boundary.

In accordance with some embodiments, in Step 303, the device compares the obtained distance with a trigger distance.

In accordance with some embodiments, in Step 304, when the obtained distance is greater than the trigger distance, the device moves the clickable animated object in a direction approaching the pointer cursor on the display.

In accordance with some embodiments, in Step 305, when the obtained distance is no greater than the trigger distance, the device maintains a current position of the clickable animated object on the display.

The principle of such design is that when the obtained distance is long, the animated object should move towards the pointer cursor or contact so that when the user wants to click the object, it is easier to do so. Also, a moving object is more fun to watch and catches the user's attention, especially when the object looks like it is chasing the pointer cursor or contact. Therefore, in some embodiments, the trigger distance is the distance beyond which the object is moving towards the cursor.

In accordance with some embodiments, the trigger distance may vary based on the movement of the pointer cursor or contact. In some embodiments, before comparing the obtained distance with the trigger distance, the device obtains a moving speed and a moving direction of the pointer cursor or contact on the display; and determines the trigger distance in accordance with the obtained moving speed and moving direction of the pointer cursor or contact. For example, when the pointer cursor or contact is moving towards the clickable animated object, the determined trigger distance is shorter than when the cursor is not moving towards the clickable animated object. The principle of the aforementioned design is that when the pointer cursor or contact is moving towards the clickable animated object, the user is possibly trying to click the animated object, so that there is no need to move any closer. Keeping the object in its current position also makes the clicking easier.

There can be multiple ways of defining “the pointer cursor or contact moving towards the clickable animated object.” In some embodiments, any movement that shortens the distance between the pointer cursor or contact and the object is deemed as “moving towards,” i.e., of all the directions, half of them are deemed as “moving towards” while the other half are deemed as “moving away.” In some embodiments, “moving towards” has a more limited definition. For example, only when the direction of movement is right towards the object, allowing for some margin of difference, the movement can be said to be moving towards the object. For example, FIG. 8B shows a more limited definition of “moving towards.” Only when the cursor is moving to a direction that is between the two arrows, the cursor is deemed as “moving towards” the animated bird. This definition can be based on the purpose of judging whether the user is intending to click the object.

In accordance with some embodiments, moving the clickable animated object in the direction of the cursor comprises: determining a speed of moving the clickable animated object in accordance with at least the moving speed and the moving direction of the pointer cursor or contact; and moving the clickable animated object at the determined speed. For example, the object is moving faster when the cursor is moving away quickly than when the pointer cursor or contact is staying in the current position. The object may move slower when the pointer cursor or contact is moving towards the object than when the pointer cursor or contact is staying in the current position. In some embodiments, when the pointer cursor or contact is moving away from the clickable animated object, the clickable animated object follows the pointer cursor or contact at the same speed as the moving speed of the pointer cursor or contact.

In accordance with some embodiments, the movement of the clickable animated object is confined within a boundary of the advertisement. For example, the webpage displays a video, a paragraph of text, and an area with no content except advertisements. The clickable animated object is confined in the area with no content and never overlays the video or the text. When pointer cursor moves, the object follows as close as possible to the pointer cursor but never leaving the advertisement area.

In accordance with some embodiments, the movement of the clickable animated object is not confined within a boundary of the advertisement, and the clickable animated object is configured to exit the boundary of the advertisement in accordance with movement of the pointer cursor or contact away from the advertisement.

In accordance with some embodiments, the webpage includes multiple clickable animated objects, each clickable animated object being configured to trigger the display of a respective advertisement when clicked. For example, there can be three objects chasing the pointer cursor or contact and the user can select by clicking one of them.

In accordance with some embodiments, the device changes the content of the clickable animated object in accordance with the movement of the pointer cursor or contact. For example, an animated cat appears to be anxious when a pointer cursor is moving away and happy when a pointer cursor is moving closer.

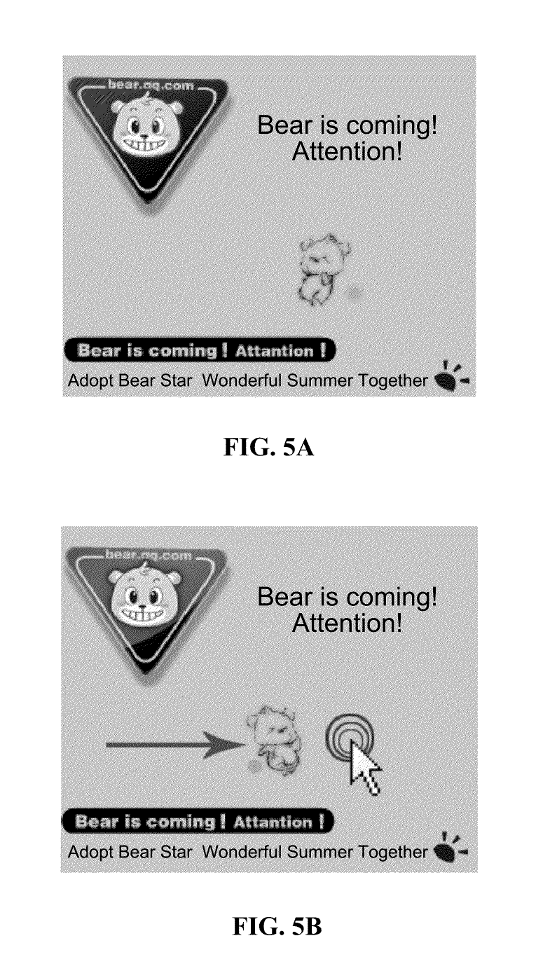

FIG. 4 is a diagram of an example implementation of the device 400 in accordance with some embodiments. While certain specific features are illustrated, those skilled in the art will appreciate from the present disclosure that various other features have not been illustrated for the sake of brevity and so as not to obscure more pertinent aspects of the implementations disclosed herein. To that end, the device 400 includes one or more processing units (CPU's) 402, one or more network or other communications interfaces 408, a display 401, memory 406, and one or more communication buses 404 for interconnecting these and various other components. The communication buses may include circuitry (sometimes called a chipset) that interconnects and controls communications between system components. The memory 406 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. The memory 406 may optionally include one or more storage devices remotely located from the CPU(s) 402. The memory 406, including the non-volatile and volatile memory device(s) within the memory 406, comprises a non-transitory computer readable storage medium.

In some implementations, the memory 406 or the non-transitory computer readable storage medium of the memory 406 stores the following programs: modules and data structures, or a subset thereof including an operating system 416, a network communication module 418, an advertisement module 420, and a web browser 424.

In accordance with some embodiments, the operating system 416 includes procedures for handling various basic system services and procedures for performing hardware dependent tasks.

In accordance with some embodiments, the network communication module 418 facilitates communication with other devices via the one or more communication network interfaces 408 (wired or wireless) and one or more communication networks, such as the internet, other wide area networks, local area networks, metropolitan area networks, etc.

In accordance with some embodiments, the advertisement module 420 is configured to display an animated object in a webpage, move the animated object in response to the movement of a pointer cursor or contact, and display the advertisement in response to predetermined clicking operation. In accordance with some embodiments, the advertisement module 420 includes a display module 421, a distance module 422, and a movement module 423. The display module 421 is configured to display the advertisement on display 401, change the content of the advertisement, and display any additional advertisement content after receiving clicking operation by a user on the animated object. The distance module 422 is configured to obtain the distance between the pointer cursor or contact and the object, determine the trigger distance in accordance with the movement of the pointer cursor or contact, and compare the obtained distance with the trigger distance. The movement module 423 is configured to move the animated object in accordance with the comparison result from the distance module 422.

In accordance with some embodiments, the web browser 424 can be any web browser, such as Chrome, Internet Explorer (IE), Firefox, etc. In some embodiments, the advertisement module 420 is an add-on or a module of the web browser 424.

While particular embodiments are described above, it should be understood they are not intended to limit the disclosure to these particular embodiments. On the contrary, the technology includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so they do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the technology to the precise forms disclosed. Many modifications and variations are possible in view of the above teachings. The embodiments were chosen and described in order to best explain the principles of the technology and their practical applications, to thereby enable others skilled in the art to best utilize the technology and various embodiments with various modifications as are suited to the particular use contemplated.

What is claimed is:

1. A method of displaying an advertisement in a webpage, comprising:
at a device of having one or more processors, memory, and a display:
displaying a clickable animated object associated with the advertisement on the display;
obtaining a distance between the clickable animated object and a current position of a pointer cursor or contact on the display; and
comparing the obtained distance with a trigger distance:
when the obtained distance is greater than the trigger distance, moving the clickable animated object in a direction approaching the pointer cursor or contact on the display; and
when the obtained distance is no greater than the trigger distance, maintaining a current position of the clickable animated object on the display.

2. The method of claim 1, further comprising:
before comparing the obtained distance with the trigger distance, obtaining a moving speed and a moving direction of the pointer cursor or contact on the display; and
determining the trigger distance in accordance with the obtained moving speed and moving direction of the pointer cursor or contact.

3. The method of claim 2, wherein moving the clickable animated object in the direction of the pointer cursor or contact on the display comprises:
determining a speed of moving the clickable animated object in accordance with at least the moving speed and the moving direction of the pointer cursor or contact; and
moving the clickable animated object at the determined speed.

4. The method of claim 1, further comprising:
detecting a clicking operation when the pointer cursor or contact is placed on the clickable animated object; and
in response to the clicking operation, displaying the advertisement associated with the clickable animated object.

5. The method of claim 1, wherein the clickable animated object is displayed concurrently with the advertisement, and the method further comprises:
detecting a clicking operation when the pointer cursor or contact is placed on the clickable animated object; and
in response to the clicking operation, displaying additional content associated with the advertisement.

6. The method of claim 5, wherein the movement of the clickable animated object is confined within a boundary of the advertisement.

7. The method of claim 1, further comprising:
acquiring information of a user of the device; and
determining at least part of content of the clickable animated object in accordance with the acquired information of the user.

8. A device of displaying an advertisement in a webpage, comprising:
a display;
one or more processors; and
memory storing one or more programs for execution by the one or more processors, the one or more programs including instructions for:
displaying a clickable animated object associated with the advertisement on the display;
obtaining a distance between the clickable animated object and a current position of a pointer cursor or contact on the display; and
comparing the obtained distance with a trigger distance:
when the obtained distance is greater than the trigger distance, moving the clickable animated object in a direction approaching the pointer cursor or contact on the display; and
when the obtained distance is no larger than the trigger distance, maintaining a current position of the clickable animated object on the display.

9. The device of claim 8, further comprising:
before comparing the obtained distance with the trigger distance, obtaining a moving speed and a moving direction of the pointer cursor or contact on the display; and
determining the trigger distance in accordance with the obtained moving speed and moving direction of the pointer cursor or contact.

10. The device of claim 9, wherein moving the clickable animated object in the direction of the cursor pointer or contact on the display comprises:
determining a speed of moving the clickable animated object in accordance with at least the moving speed and the moving direction of the pointer cursor or contact; and
moving the clickable animated object at the determined speed.

11. The device of claim 8, wherein the operations further comprise:
detecting a clicking operation when the pointer cursor or contact is placed on the clickable animated object; and
in response to the clicking operation, displaying the advertisement associated with the clickable animated object.

12. The device of claim 8, wherein the clickable animated object is displayed concurrently with the advertisement, and the method further comprises:
detecting a clicking operation when the pointer cursor or contact is placed on the clickable animated object; and
in response to the clicking operation, displaying additional content associated with the advertisement.

13. The device of claim 12, wherein the movement of the clickable animated object is confined within a boundary of the advertisement.

14. The device of claim 8, wherein the operations further comprise:
acquiring information of a user of the device; and
determining at least part of content of the clickable animated object in accordance with the acquired information of the user.

15. A non-transitory computer readable storage medium having instructions stored thereon, the instructions, when executed by one or more processors, cause the processors to perform operations comprising:
displaying a clickable animated object associated with the advertisement on a display;
obtaining a distance between the clickable animated object and a current position of a pointer cursor or contact on the display; and
comparing the obtained distance with a trigger distance:
when the obtained distance is greater than the trigger distance, moving the clickable animated object in a direction approaching the pointer cursor or contact on the display; and
when the obtained distance is no larger than the trigger distance, maintaining a current position of the clickable animated object on the display.

16. The non-transitory computer readable storage medium of claim 15, wherein the operations further comprise:
before comparing the obtained distance with the trigger distance, obtaining a moving speed and a moving direction of the pointer cursor or contact on the display; and
determining the trigger distance in accordance with the obtained moving speed and moving direction of the pointer cursor or contact.

17. The non-transitory computer readable storage medium of claim 16, wherein moving the clickable animated object in the direction of the cursor pointer or contact on the display comprises:
determining a speed of moving the clickable animated object in accordance with at least the moving speed and the moving direction of the pointer cursor or contact; and
moving the clickable animated object at the determined speed.

18. The non-transitory computer readable storage medium of claim 15, wherein the operations further comprise:
detecting a clicking operation when the pointer cursor or contact is placed on the clickable animated object; and
in response to the clicking operation, displaying the advertisement associated with the clickable animated object.

19. The non-transitory computer readable storage medium of claim 15, wherein the clickable animated object is displayed concurrently with the advertisement, and the method further comprises:
detecting a clicking operation when the pointer cursor or contact is placed on the clickable animated object; and
in response to the clicking operation, displaying additional content associated with the advertisement.

20. The non-transitory computer readable storage medium of claim 19, wherein the movement of the clickable animated object is confined within a boundary of the advertisement.
